(19) United States
(12) Patent Application Publication
(10) Pub. No.: US 2010/0023173 A1
(43) Pub. Date: Jan. 28, 2010

(54) Irrigation system and method

(76) Inventor: Wen Chen Wu, Port Chester, NY (US)

Correspondence Address: STEVEN N. FOX, ESQ., P.O. BOX 251, CANTON, MA, 02021, US

(21) Appl. No.: 12/220,452

(22) Filed: Jul. 24, 2008

(51) Int. Cl. G05D 7/06

(52) U.S. Cl. 700/284

(57) ABSTRACT

The present invention is an irrigation device and method for use with a water source to deliver water in an intelligently controlled manner to a sprinkler system for watering. In one embodiment, the device comprises a housing having front and rear walls, a fluid inlet conduit engaged with the front wall and adapted to engage a water source such as a spout or hose, and a fluid outlet conduit engaged with the rear wall. The device further comprises a valve unit disposed within the outlet conduit. The valve unit is operable between a closed position where water flow is prevented and an open position where water can flow thru the outlet conduit to the external sprinkler system for watering. The device further comprises a control system having a micro-controller, a storage device coupled to the micro-controller, a barometric pressure sensor coupled to the micro-controller to sense the barometric pressure of the outside air, a humidity sensor coupled to the micro-controller to sense the humidity of the outside air, and a temperature sensor coupled to the micro-controller to sense the temperature of the outside air. The control system is electrically coupled to a motor drives a plurality of gears to open and close the valve unit. The control system further comprises a weather forecast module stored in a memory storage device electronically coupled to the micro-controller to provide past and future weather forecast conditions such as rainy, cloudy, or sunny/partly cloudy. The control system further comprises a watering control module stored in the memory storage device electronically coupled with the micro-controller. The watering control module using temperature and humidity readings, and together with past and future weather conditions from the weather forecast module, intelligently instructs the micro-controller when to activate the valve unit to allow watering thereby saving a significant amount of water.

### BACKGROUND OF THE INVENTION

The present invention generally relates to irrigation systems. Conventional irrigation systems that use time to control watering cycles is inadequate due to the possibility of rainfall either right after watering or even during watering, and the water is then wasted. Other known systems mechanically sense rainfall in order to control irrigation. This system is likewise inadequate as the rain may come right after a scheduled watering cycle. Still other known systems use soil moisture content to control watering cycles and watering durations. This method is also inadequate because topography is not normally level and the flow of water will cause the soil in some part to be either more or less watered or moisturized than in other parts. Even if the topography appears to be level to the naked eye, the soil can be slanted enough to cause run off. Also, trees or other landscape elements will cause the rain fall to vary from point to point.

### SUMMARY OF THE INVENTION

The present invention is an irrigation device and method for use with a water source to deliver water in an intelligently controlled manner to a sprinkler system for watering. In one embodiment, the device comprises a housing having front and rear walls, a fluid inlet conduit engaged with the front wall and adapted to engage a water source such as a spout or hose, and a fluid outlet conduit engaged with the rear wall. The device further comprises a valve unit disposed within the outlet conduit. The valve unit is operable between a closed position where water flow is prevented and an open position where water can flow thru the outlet conduit to the external sprinkler system for watering. The device further comprises a control system having a micro-controller, a storage device coupled to the micro-controller, a barometric pressure sensor coupled to the micro-controller to sense the barometric pressure of the outside air, a humidity sensor coupled to the micro-controller to sense the humidity of the outside air, and a temperature sensor coupled to the micro-controller to sense the temperature of the outside air. The control system is electrically coupled to a motor drives a plurality of gears to open and close the valve unit. The control system further comprises a weather forecast module stored in a memory storage device electronically coupled to the micro-controller to provide past and future weather forecast conditions such as rainy, cloudy, or sunny/partly cloudy. The control system further comprises a watering control module stored in the memory storage device electronically coupled with the micro-controller. The watering control module using temperature and humidity readings, and together with past and future weather conditions from the weather forecast module, intelligently instructs the micro-controller when to activate the valve unit to allow watering thereby saving a significant amount of water.

### BRIEF DESCRIPTION OF THE DRAWINGS

The following detailed description of the invention will more fully understood with reference to the accompanying drawings wherein:

FIG. 1 illustrates an outside view of the irrigation control system according to the present invention;

FIG. 2 is a block diagram depicting the architecture of the vale units;

FIG. 3 is a block diagram depicting the architecture of the irrigation control system;

FIGS. 4A and 4B is a flowchart showing the operation of the irrigation control system;

FIG. 5A is an illustration of a first display screen of a display device of the irrigation control system; and

FIG. 5B is an illustration of a second display screen of a display device of the irrigation control system.

### DETAILED DESCRIPTION OF THE INVENTION

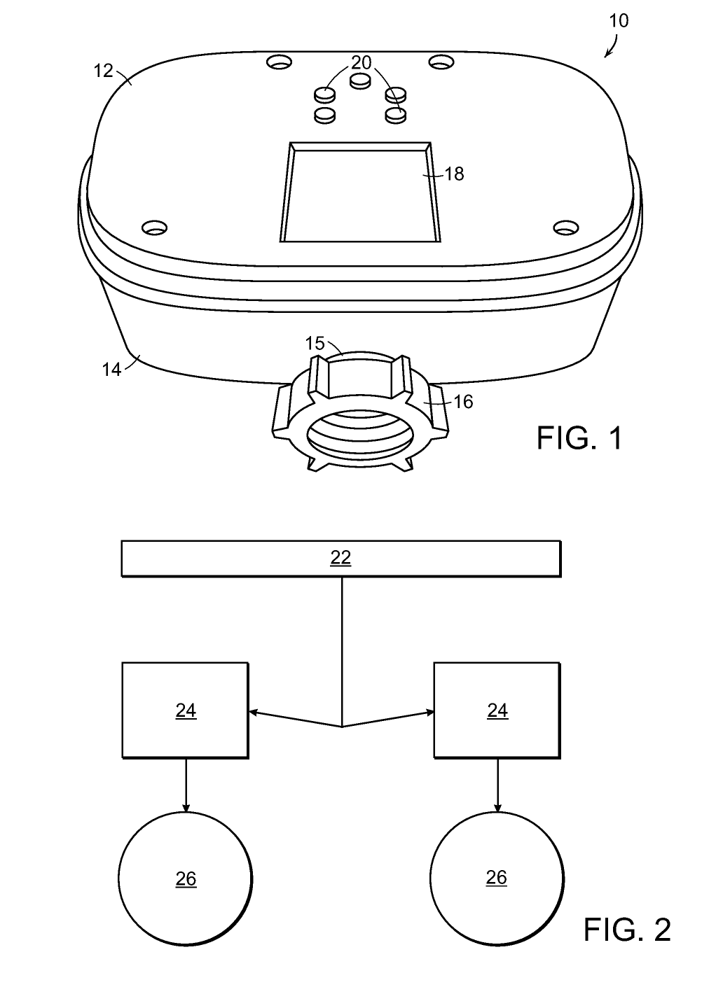

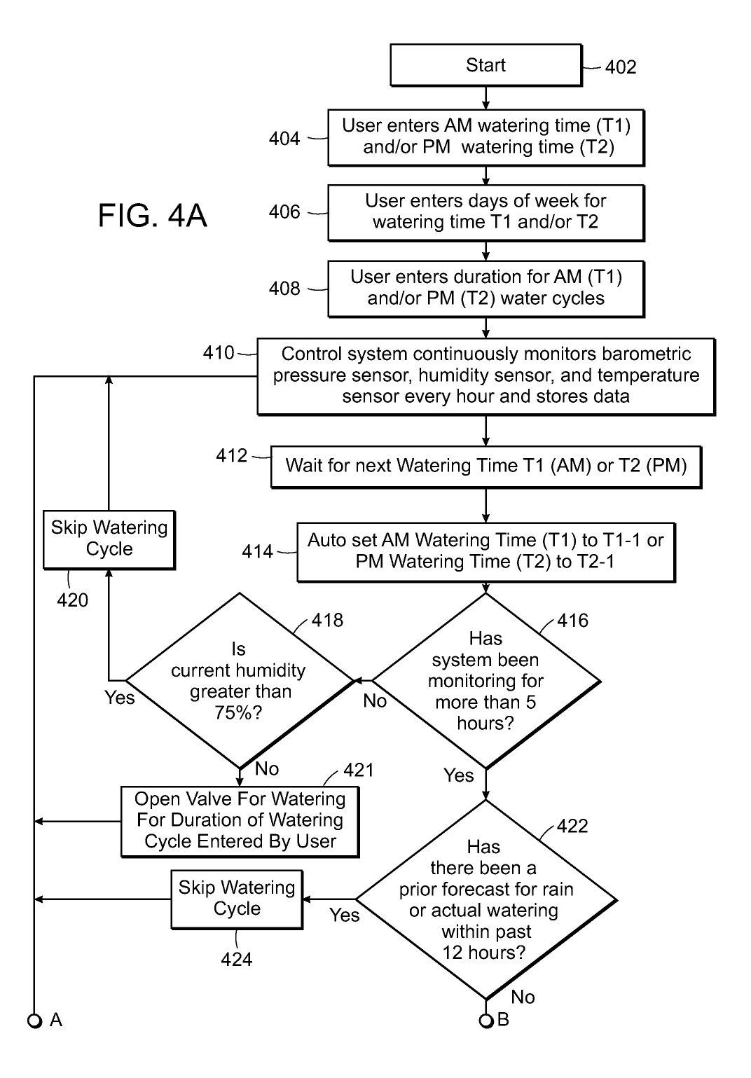

Referring to FIG. 1, an outside perspective view of a irrigation control device 10 is shown. Device 10 comprises a housing, which includes a lid 12 and a housing body 14. Lid 12 and housing body 14 are sealed together by a set of transposing elements such as screws (not shown), a gasket or rubber band is interposed between lid 12 and housing body 14 to improve the sealing. Housing body 14 comprises an inlet conduit 15 formed as part of the floor of housing body 14. Inlet conduit 15 has an end portion extending outward of housing body 14. A threaded fluid inlet collar 16 is mounted about end portion of inlet conduit 15 to receive a threaded water delivery source such as a spout or a connector of a hose (not shown). Inlet conduit 15 is disposed to receive incoming fluid such as water into device 10. Inlet conduit 15 is in communication with outlet fluid conduits 17 and 19 (FIG. 3) which are formed as part of the floor of housing body 14. Outlet fluid conduits 17 and 19 each have a threaded end portion 36 extending outward of housing body 14 adapted to engaged with an external water deliver source such as a connector of a hose (not shown). Lid 12 comprises a display 18 electronically coupled to a circuit board (not shown herein) and input elements 20 such as keys adapted to human fingers for input action.

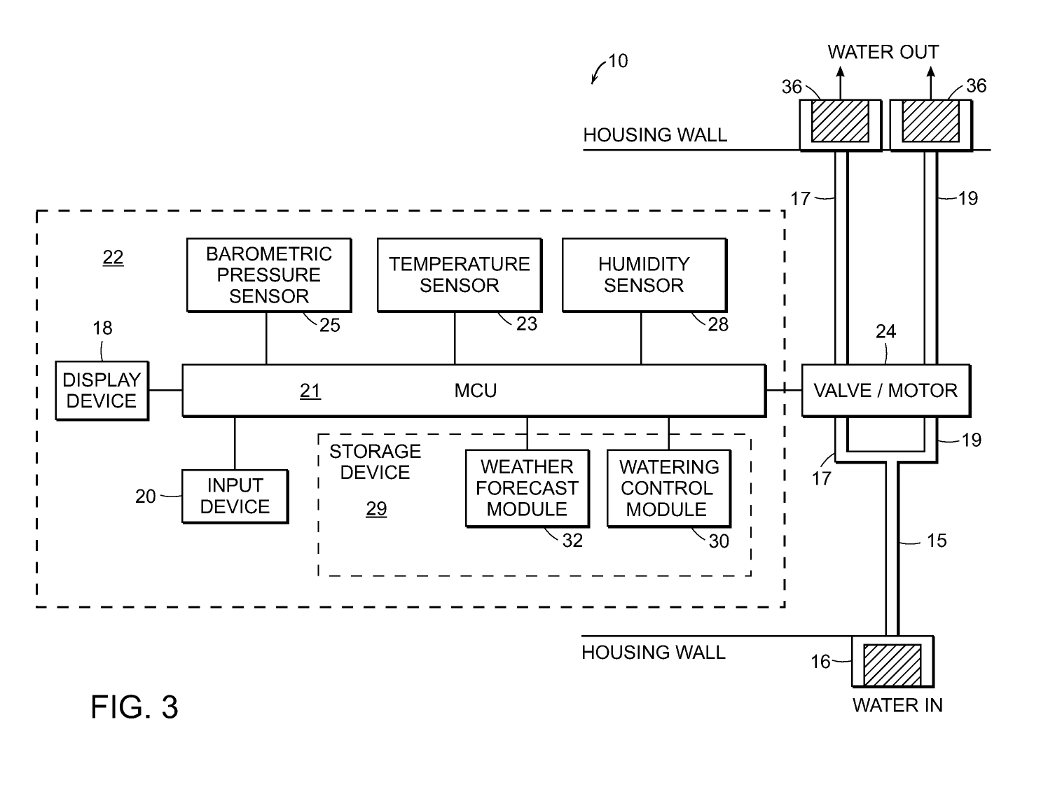

Referring to FIG. 2, a block diagram depicting the inside of the irrigation device is shown. A circuit board 22 electrically coupled to a valve unit 24 for controlling the ON/OFF switch or valve. When valve unit 24 is “ON”, fluid flows into an out-let 26, and in turn, out of device 10 for irrigation. Otherwise, no fluid flows into out-let 26, hence out of device 10. Note that a pair or two valve units 24 and out-lets 26 are depicted herein FIG. 2. However, the present invention contemplates other combinations of valve units 24 and out-lets 26 as well. For example, there may be only one valve unit 24 controlling both out-lets 26.

Referring to FIG. 3, a block diagram depicting the irrigation device 10 is shown. Within the housing of device 10, there is the circuit board 22 positioned therein. On or coupled to circuit board 22, there is a micro control unit (MCU) 21. MCU 21 is coupled to, and receives a set of sensed information from a set of sensors in electronic form. The set of sensors respectively and periodically provide sensed information to MCU 21 for processing. The set of sensors comprises a temperature sensor 23, a barometric pressure sensor 25, and a humidity sensor 28. MCU 21 is further coupled to display 18, and adapted to provide information for display. Display 18 may be a light emitting diode (LED) device. MCU 21 is still further coupled to input elements 20, which input information to device 10. MCU 21 is also coupled to valve unit 24. Valve unit 24 is disposed within each of outlets conduits 17 and 19. When a motor (not shown) is activated, valve unit 24 is opened or at “ON” position allowing fluid communication thru outlet conduits 17 and 19. Otherwise, no fluid communication is allowed thru outlet conduits 17 and 19. Although only one valve unit 24 is shown, there is one valve unit disposed in each of outlet conduits 17 and 19 and there is one motor (not shown) associated with each valve unit 24 that is controlled by commands from MCU 21. Each of the motors (not shown) coupled with each valve units 24, respectively, are controlled by an electrical command signal sent by MCU 21 to drive a series of gears (not shown) that independently open or close each valve unit 24 disposed within outlet conduits 17 and 19 to allow fluid flow in one or both of outlet conduit 17 and/or 19. MCU 21 comprises firmware storing data and control information for processing the device 10. MCU 21 is coupled to and interacts with a watering control module 30 containing instructions (to be described) and a weather forecast module 32, together for determining whether to open/close one or both of valve units 24 at a point in a time line. Watering control module 30 and weather forecast module 32 are adapted to be stored in a memory storage device 29 such as a well known and widely available EPROM or EEPROM. A plurality of batteries (not shown) are contained within housing body 14 to provide power to the various electronic components. Pressure sensor 25, humidity sensor 28, and temperature sensor 23 are well known and widely available.

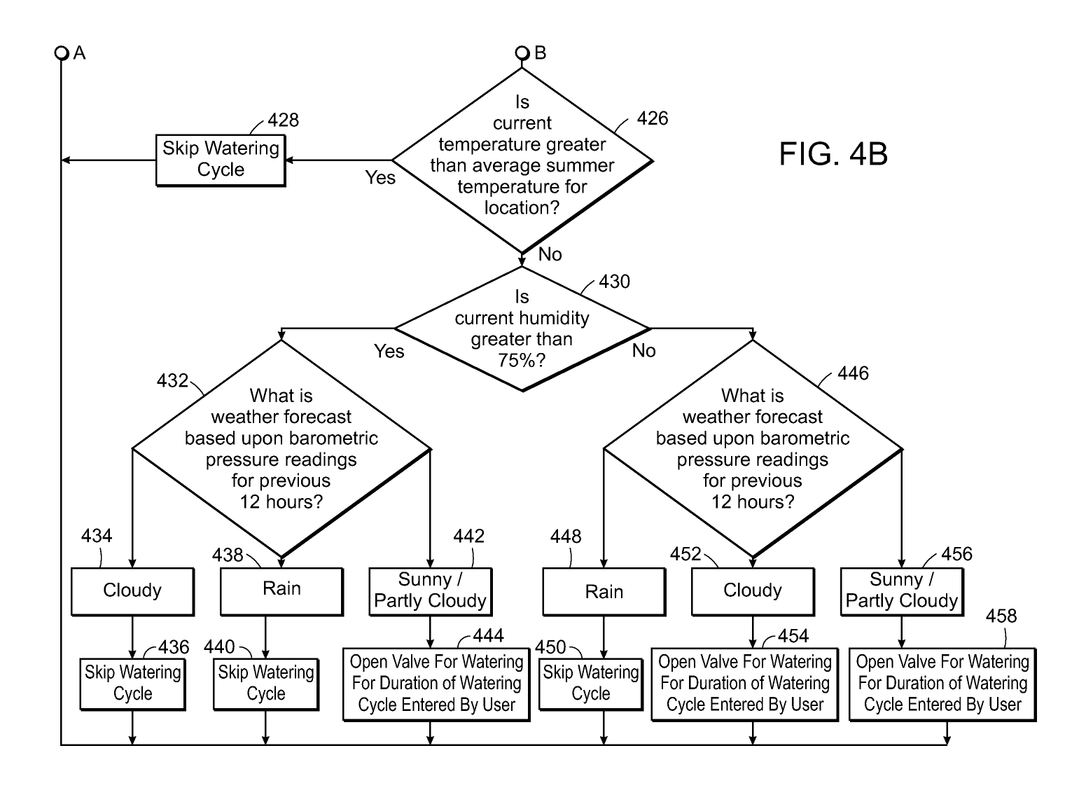

Referring to FIGS. 4A-4B, wherein the process or method of operation of watering control module 30 is described. Block 402 indicates a step of starting and initializing the process of method of operation of watering control module 30. Control is passed to block 404 where the user enters a morning (AM) watering time T1 and/or an afternoon (PM) watering time T2. Control is passed to block 406 where the user enters which days of the week watering at watering times T1 and/or T2 is desired. Control is passed to block 408 where the user enters the duration of the morning (AM) watering time T1 and/or the afternoon (PM) water time T2. Control is passed to block 410 where watering control module 30 instructs MCU 21 to continuously monitor the barometric pressure sensor 25, temperature sensor 23, and humidity sensor 28 each hour and stores such data in storage device such as the firmware described supra for the last twelve hours. Note that the firmware may be Erasable Programmable Read-Only Memory (EPROM) or Electrically Erasable Programmable Read-Only Memory (EEPROM). Control is passed to block 412 where watering control module 30 instructs MCU 21 to wait for the next water time T1 or T2, whichever comes first. Control is passed to block 414 where upon the MCU 21 sensing the watering time T1 or T2, it re-sets the watering time to a time T1-1 or T2-1 as the case may be which is immediate prior to the watering time set by the user. Control is passed to decisional block 416 where a determination is made as to whether prior or initial operation of the control system is less than a predetermined time, for example five hours, thereby having stored historical forecast information. If the control system has not been monitoring for more than five hours then control is passed to decisional block 418 where watering control module 30 instructs MCU 21 to determine if the current humidity sensed from humidity sensor 28 is greater than seventy-five percent. If the current humidity is greater than seventy-five percent than control is passed to block 420 where watering control module 30 instructs MCU 21 to skip the watering current watering cycle for T1 or T2 as the case may be. Control is then returned to block 410 for monitoring and block 412 where watering module 30 instructs MCU 21 to wait for the next water time T1 or T2. Returning to decisional block 416, if the control system has been monitoring for more than five hours then control is passed to decisional block 422. As indicated by decisional block 422, watering control module 30 is adapted to instruct MCU 21 to determine whether there has been a prior rain forecast or an actual watering within past twelve hours. If there has been a prior rain forecast or actual watering within the past twelve hours, then control is passed to block 424 where watering module 30 is adapted to instruct MCU 21 to skip the current watering cycle and keep valve unit 24 off. Control is then returned to block 410 for monitoring and block 412 where watering module 30 instructs MCU 21 to wait for the next water time T1 or T2. Returning to decisional block 422, if there has not been a prior rain forecast or actual watering within the past twelve hours then control is passed to decisional block 426 where watering module 30 is adapted to instruct MCU 21 to determine whether the current temperature from the temperature sensor 23 is greater than the average summer temperature for the location. The average summer temperature will vary depending upon the location where the irrigation device 10 is used. Although not described heretofore, the user is prompted to enter the average summer temperature for the user's location during initialization. If the current temperature is greater than the average summer temperature then control is passed to block 428 where watering module 30 is adapted to instruct MCU 21 to skip the current watering cycle and keep valve unit 24 off. Control is then returned to block 410 for monitoring and block 412 where watering module 30 instructs MCU 21 to wait for the next water time T1 or T2. Returning to decisional block 426, if the current temperature is less than the average summer temperature then control is passed to decisional block 430 where watering module 30 is adapted to instruct MCU 21 to determine if the current humidity from humidity sensor 28 is greater than seventy-five percent. If the current humidity is greater than seventy-five percent then control is passed to decisional block 432 where watering module 30 is adapted to instruct MCU 21 determine what is the future weather forecast from weather forecast module 32. As shown by blocks 434 and 436, if the future weather forecast from weather forecast module 32 is a cloudy condition then watering module 30 instructs MCU 21 to skip the current watering cycle and keep valve unit 24 off. Control is then returned to block 410 (FIG. 4A) for monitoring and block 412 (FIG. 4A) where watering module 30 instructs MCU 21 to wait for the next water time T1 or T2. Returning to decisional block 432, as shown by blocks 438 and 440 if the future weather forecast from weather forecast module 32 is a rainy condition then watering module 30 instructs MCU 21 to skip the current watering cycle and keep valve unit 24 off. Control is then returned to block 410 (FIG. 4A) for monitoring and block 412 (FIG. 4A) where watering module 30 instructs MCU 21 to wait for the next water time T1 or T2. Returning to decisional block 432, as shown by blocks 438 and 440 if the future weather forecast from weather forecast module 32 is a sunny/partly cloudy condition then watering module 30 instructs MCU 21 to activate or turn on valve unit 24 for watering. Control is then returned to block 410 (FIG. 4A) for monitoring and block 412 (FIG. 4A) where watering module 30 instructs MCU 21 to wait for the next water time T1 or T2. Returning to decisional block 430, if the current humidity is less than seventy-five percent then control is passed to decisional block 446 where watering module 30 is adapted to instruct MCU 21 determine what is the future weather forecast from weather forecast module 32. As shown by blocks 448 and 450, if the future weather forecast from weather forecast module 32 is a rainy condition then watering module 30 instructs MCU 21 to skip the current watering cycle and keep valve unit 24 turned off. Control is then returned to block 410 (FIG. 4A) for monitoring and block 412 (FIG. 4A) where watering module 30 instructs MCU 21 to wait for the next water time T1 or T2. Returning to decisional block 446, as shown by blocks 452 and 454, if the future weather forecast from weather forecast module 32 is a cloudy condition then watering module 30 instructs MCU 21 to activate or turn on valve unit 24 for watering. Control is then returned to block 410 (FIG. 4A) for monitoring and block 412 (FIG. 4A) where watering module 30 instructs MCU 21 to wait for the next water time T1 or T2. Returning to decisional block 446, as shown by blocks 456 and 458 if the future weather forecast from weather forecast module 32 is a sunny/partly cloudy condition then watering module 30 instructs MCU 21 to activate or turn on valve unit 24 for watering. Control is then returned to block 410 (FIG. 4A) for monitoring and block 412 (FIG. 4A) where watering module 30 instructs MCU 21 to wait for the next water time T1 or T2. As will be understood by the above operation of watering control module 30, water is saved each time a water cycle is skipped which amounts to at least a fifty percent savings.

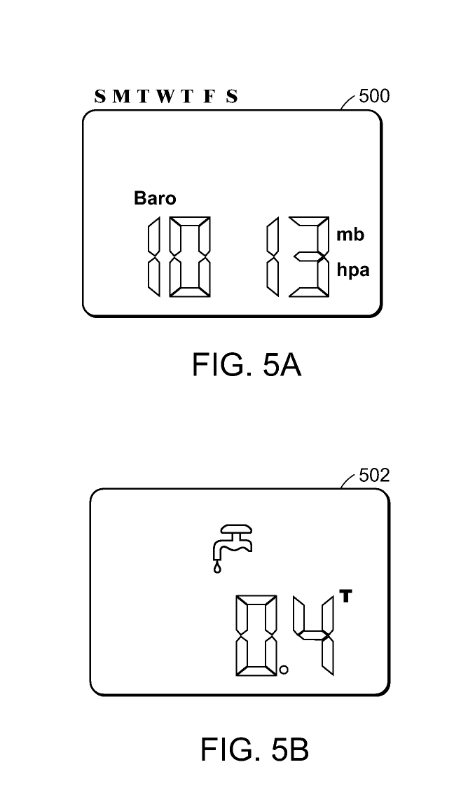

Referring to FIG. 5A, a first display screen 500 of display device 18 of irrigation device 10 is shown. In the embodiment shown, display device 18 is a liquid crystal display (LCD). From an initial screen (not shown) of display 18 of FIG. 1, the user presses MODE key twice using input elements 20 and the barometric pressure reading is shown. Altitude information of the installed location needs to be entered by the user to be used by the MCU 21 of FIG. 3. In other embodiments, the altitude information may be acquired independent of device 10 such as from a handheld GPS device, or via the Internet from site such as Google Earth, etc.

Referring to FIG. 5B, a second display screen 502 of display device 18 is shown. In display screen 502, a measure of how much water has been saved for a predetermined time is shown.

Although not shown in the drawings, the irrigation device 10 allows a user to manually activate or open valve unit 24. If the user desires to manually turn the motors on, the user may press a “MANUAL” button (not shown) while in an initial set up screen (also not shown). The Manual button may be used to select which valve unit 24 the user desires to be opened (also designated MA or MB). After the user has made his/her selection, the user may press “SET” set key (not shown). If the user wants to open the other valve as well, repeat this step. To close one of the valves, the user may press the“MANUAL” key and select the valve the user wishes to close and press “SET.” If the user wants to close the other valve as well, this step is repeated.

The foregoing description is intended primarily for purposes of illustration. This invention may be embodied in other forms or carried out in other ways without departing from the spirit or scope of the invention. Modifications and variations still falling within the spirit or scope of the invention will be readily apparent to those of skill in the art.

What is claimed is:

1. An irrigation device for use with a water source to deliver water in a controlled manner to a desired location for watering, the device comprises:
(a) a housing having first and second walls;
(b) an inlet port engaged with said first wall and adapted to engage with the water source;
(c) an outlet port engaged with said second wall;
(d) a valve unit coupling said inlet port with said outlet port; said valve unit being operable between a closed position where the water is prevented from flowing out of said outlet port and an open position where the water flows out of said outlet port for watering; and
(e) a control system mounted within said housing and comprising a micro-controller; a storage device coupled to said micro-controller; a barometric pressure sensor coupled to said micro-controller to sense the barometric pressure of outside air, a humidity sensor coupled to said micro-controller to sense a humidity of outside air, and a temperature sensor coupled to said micro-controller to sense a temperature of outside air; said control system is electrically coupled to said valve unit to activate said valve unit between said open and closed positions; said control system further comprising a weather forecast module stored in said storage device that is electronically coupled with said micro-control unit; said weather forecast module being adapted to instruct said micro-controller to obtain a barometric pressure reading from said barometric pressure sensor at a plurality of times and to store said plurality of barometric pressure readings; said weather forecast module being adapted to output a first command to said micro-controller indicative of a sunny/partly cloudy future weather forecast, a second command to said micro-controller indicative of a cloudy future weather forecast, a third command to said micro-controller indicative of a rainy future weather forecast; a fourth command to said micro-controller indicative of a prior sunny/partly cloudy weather condition, a fifth command to said micro-controller indicative of a prior cloudy weather condition, and a sixth command to said micro-controller indicative of a prior rainy weather condition; said control system further comprising a watering control module stored in a storage device that is electronically connected with said micro-controller; said watering control module being adapted to instruct said micro-controller to determine whether there has been a prior rain forecast or actual watering within past twelve hours; said watering module being adapted to instruct said micro-controller to keep said valve unit off if there has been a prior rain forecast or actual watering within a past given amount of time; said watering module being adapted to instruct said micro-controller to determine whether the current temperature from said temperature sensor is greater than the average summer temperature for the location if there has not been a prior rain forecast or an actual watering within a given period of time; said watering module being adapted to instruct said micro-controller to keep said valve unit off if said current temperature is greater than the average summer temperature for the location; said watering module being adapted to instruct said micro-controller to determine if the current humidity from said humidity sensor is greater than seventy-five percent; said watering module being adapted to instruct said micro-controller to skip the watering cycle if said current humidity is greater than seventy-five percent and said future weather forecast from said weather forecast module is said cloudy condition; said watering module being adapted to instruct said micro-controller to skip the watering cycle if said current humidity is greater than seventy-five percent and said future weather forecast from said weather forecast module is said rainy condition; said watering module being adapted to instruct said micro-controller to turn-on said valve unit for watering if said current humidity is greater than seventy-five percent and said future weather forecast from said weather forecast module is said sunny/partly cloudy condition; said watering module being adapted to instruct said micro-controller to skip the watering cycle if said current humidity is less than seventy-five percent and said future weather forecast from said weather forecast module is said rainy condition; said watering module being adapted to instruct said micro-controller to turn-on said valve unit for watering if said current humidity is less than seventy-five percent and said future weather forecast from said weather forecast module is said cloudy condition; said watering module being adapted to instruct said micro-controller to turn-on said valve unit for watering if said current humidity is less than seventy-five percent and said future weather forecast from said weather forecast module is said sunny/partly cloudy condition; and whereby water is saved each time a water cycle is skipped.
